(19) United States
(12) Patent Application Publication
(10) Pub. No.: US 2014/0237501 A1
(43) Pub. Date: Aug. 21, 2014

(54) Systems and Methods for Customizing Presentation of Video Content

(71) Applicant: Mark L. Berrier, Austin, TX (US)

(72) Inventor: Mark L. Berrier, Austin, TX (US)

(21) Appl. No.: 14/185,777

(22) Filed: Feb. 20, 2014

Related U.S. Application Data
(60) Provisional application No. 61/767,618, filed on Feb. 21, 2013.

(51) Int. Cl. H04N 21/44; H04N 21/2387

(52) U.S. Cl. CPC H04N 21/44008; H04N 21/2387
USPC 725/25

(57) ABSTRACT

Systems and methods for customized presentation of video content. In one embodiment, a system includes a processor coupled to one or more data sources that store video content and skip data which identifies potentially objectionable portions of the video content. The processor identifies a user-provided indication of a level of objectionability and determines which portions of the video content are objectionable based on the skip data and user input. The video content that is not indicated to be objectionable is displayed to a user via a video display device, while those portions that are indicated to be objectionable are inhibited by the processor (e.g., by distorting them or simply not displaying them at all). The skip data may be stored independently of the video content, and may be used to customize presentation of the same video content differently for different viewers.

### CROSS-REFERENCE TO RELATED APPLICATIONS

This application is a conversion of, and claims the benefit of U.S. Provisional Patent Application 61/767,618, filed Feb. 21, 2013, which is incorporated by reference as if set forth herein in its entirety.

### BACKGROUND

The invention relates generally to presentation of video content, and more particularly to identifying portions of the video content that a user does not want to be displayed, and inhibiting the identified portions when the video content is played.

As video technology has developed and become increasingly advanced, more and more video content has become readily available to users. Video content is available through many different delivery channels, including, but not limited to, DVDs, Blu-Ray discs, streaming, etc. In addition to the increasing number of delivery mechanisms through which video content is available, an increasing number of video titles (e.g., movies, “television” shows, etc.) has become available. These video titles include more current releases, as well as older content that has recently been converted to a digital format.

Despite the increasing availability and selection of video content, it seems that it is becoming increasingly difficult to find the content that is suitable for viewing by children, adolescents, and even young adults. Although some movies and television shows may be objectionable in their entirety, there are many that viewers would find suitable for viewing by younger audiences except for the presence of one or more (sometimes very brief) objectionable scenes. For example, a movie may contain content that is entirely appropriate for children, except for a moment of profanity or nudity. This single moment in the movie may cause a parent to prevent children from watching the movie

Currently, if a parent or other adult wishes to watch a movie that contains some objectionable content, but does not wish for others (e.g., children) to be subjected to this objectionable content, only a few options are available. One option is to simply not watch the movie. This is obviously not a satisfying alternative for the person who wishes to watch the movie. Another option is to attempt to skip over (e.g., fast-forward through) the objectionable content. Again, this is not a satisfying alternative for a number of reasons. For instance, the adult cannot simply relax and enjoy the movie, because he or she must be ready to identify the objectionable content when it is displayed, and to skip over this content. Even if the adult is willing to do this, it is often difficult to skip all the objectionable content without also skipping some of the content that is not objectionable.

### SUMMARY OF THE INVENTION

It would therefore be desirable to provide systems and methods to enable groups such as families to view more of the available video content by providing means to automatically skip (e.g. fast forwarding through or jumping over) objectionable content. It should be noted that, for purposes of brevity and clarity, “video” is used herein as shorthand for video, audio and combinations of both.

This disclosure is directed to systems and methods for presentation of video content that solve one or more of the problems discussed above. In one particular embodiment, a system includes a processor that is coupled to one or more data sources and a video display device. The data sources store video content, as well as skip data that identifies one or more potentially objectionable portions of the video content. The processor identifies the video content and skip data associated with the video content. The processor also identifies a user-provided indication of a level of objectionability, such as a level of violence or language that is acceptable (above which the violence or language is objectionable). The processor identifies one or more portions of the video content that are identified by the skip data as potentially objectionable content. Portions of this content may be designated as objectionable based on the user-provided indication of the level of objectionability. Those portions of the video content that are not indicated to be objectionable are displayed to a user through the video display device. Those portions of the video content that are indicated to be objectionable are inhibited by the processor (e.g., by distorting them or simply not displaying them at all). In one embodiment, the data sources include one or more skip data servers that are located remotely from the processor and are coupled to the processor by a network such as the internet, where the processor accesses the skip data servers via the network and thereby retrieves the skip data. In one embodiment, the data sources include one or more video content servers that are located remotely from the processor and are coupled to the processor by a network, so that the processor accesses the video content servers via the network and thereby retrieves the video content.

An alternative embodiment comprises a method for customizing presentation of video content. In this method, the video content and skip data associated with the video content are identified. A user-provided indication of a level of objectionability is also identified. The skip data identifies potentially objectionable portions of the video content. One or more of these potentially objectionable portions of the video content are identified as objectionable based on the user-provided indication of the level of objectionability. The non-objectionable portions of the video content are then presented to the user via the video display device, while presentation of the identified objectionable portions of the video content is inhibited. The objectionable portions of the video content may be inhibited in various ways, such as by skipping them, distorting (e.g., pixelating) them, or replacing them with non objectionable content. The user may identify the level of objectionability of video content by, for example, specifying a threshold level of objectionability, or by explicitly identifying objectionable portions of the content. The level of objectionability may be different for different types of content (e.g., language, violence, nudity, etc.)

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating a simple functional block diagram showing the structure of an exemplary system in one embodiment.

FIG. 2 is a functional block diagram illustrating a system in accordance with an alternative exemplary embodiment.

FIG. 3 is a diagram illustrating the manner in which the viewing of a video presentation is customized according to a particular user's desires in one embodiment.

FIG. 4 is a flow diagram illustrating one exemplary method for selectively displaying video content in one embodiment.

FIGS. 5A-5D are diagrams illustrating the manner in which alternative content is presented for display to a user in place of objectionable content in one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DESCRIPTION OF EXEMPLARY EMBODIMENTS

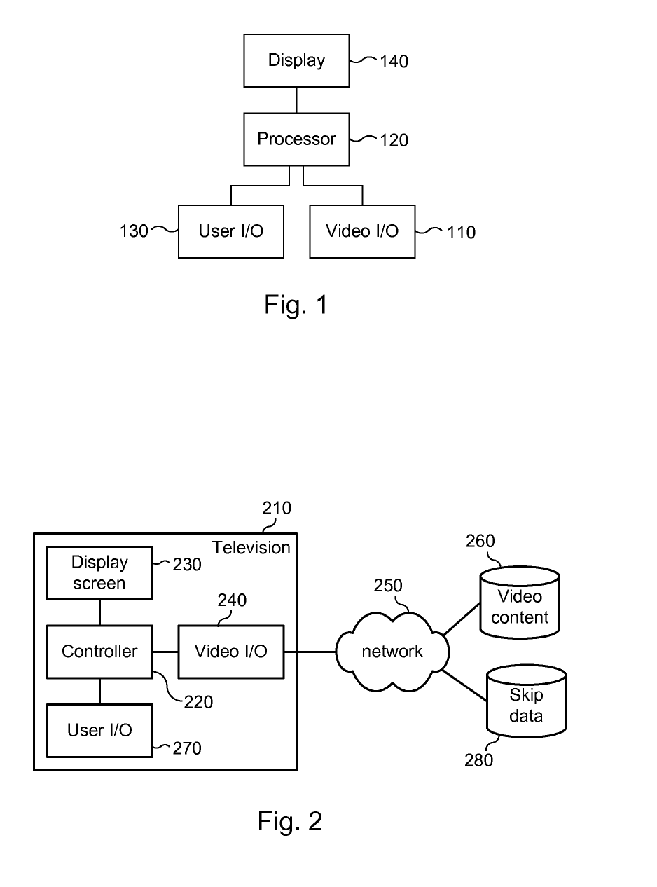

One embodiment of the present invention is a system that enables playback of video content such as movies or television shows, wherein objectionable portions of the content within these shows is identified and skipped or otherwise inhibited. Referring to FIG. 1, a simple functional block diagram illustrating the structure of an exemplary system is shown. In this system, video content is provided from a video input/output device 110 to a processor 120. Processor 120 also receives user input from user input/output device 130. Based upon information received from the user, processor 120 determines which portions of the video content received from video input/output device 110 are to be played, and which portions are to be skipped. Processor 120 then provides the appropriate video information to display 140, which displays this information to the viewers.

Referring to FIG. 2, a functional block diagram illustrating an alternative exemplary embodiment is shown. In this embodiment, the video playback system is implemented within a television 210. Television 210 includes a controller 220 which provides that information to display screen 230. Controller 220 is coupled to a communications interface 240 through which video content is received. In this example, the communications interface 240 is coupled through a network 250 (e.g., the Internet) to a video data source 260. Video data source 260 may, for example, be a server for a video service such as Netflix, Hulu, iTunes, or the like. The video data from source 260 is provided by communications interface 240 to controller 220, which processes the data for display on screen 230.

If a user wishes to view the received video content in its entirety (including any potentially objectionable material), controller 220 need not perform any processing other than that which is performed in a conventional television. If, however, the user wishes to avoid the display of the objectionable content, controller 220 is configured to perform the necessary processing to skip or otherwise inhibit display of the objectionable content. The user may provide an indication through a user input/output device 270 that this additional processing is to be performed. This indication may be actively provided by the user, or the user may have previously stored an indication on the system.

The user may provide specific instructions as to portions of the video content that are to be skipped, or the user's input may be assessed in conjunction with other sources of information. For instance, information indicating the potential objectionability of particular portions of the video content may be retrieved from a data source 280, and one or more of these portions of the video content may be skipped, depending upon the user input.

It should be noted that the data sources (260, 280) shown in FIG. 2 are merely illustrative of the possible sources of the respective types of data. The video content may be provided from a remotely located server that is accessible through the internet or other networks, it may be stored on a local storage medium that is connected directly to the video display device, or it may be provided from any other suitable source. Likewise, the skip data may be provided from a remotely located server, a local storage medium connected directly to the video display device, or it may be provided from any other suitable source. One video content source may be used with multiple, different skip data sources, and one skip data source may be used with multiple, different video content sources. Multiple, different video display devices may retrieve video content and/or skip data from the same source(s). Thus, many different viewers may access the same data at the same time, yet have different viewing experiences because they may provide different inputs to their respective video display devices, causing the devices to skip different portions of the video content.

It is contemplated that different users may find different types of content objectionable. For example, some users may find any profanity or crude language, nudity, adult situations, or graphic violence to be objectionable, while other users may not object to any type of language or violence, but may object to nudity and adult situations. Controller 220 may be configured to accept user input indicating which types of content are objectionable and which are not, and then identify the particular portions of the video content that are deemed objectionable to the particular user who is accessing the system. Controller 220 may then play back the portions of the video content which are deemed to be acceptable, while inhibiting those portions which are deemed to be objectionable.

It should be noted that there may also be different levels of objectionability within the different types of potentially objectionable content. For example, within the category of nudity, some viewers may find that rear nudity is acceptable, while full frontal nudity is not. Similarly, within the category of adult situations, some viewers may find that implied sexual references are acceptable while actual depictions of sexual activity are not. Controller 220 may therefore be configured to identify particular levels of objectionability that are acceptable (or objectionable) within different categories, and inhibit display of only those portions of the video content that exceed these levels. The system can thereby customize the viewing experiences of different users in different ways.

While the embodiment of FIG. 2 is implemented in a television, alternative embodiments may be implemented in DVD players, set-top boxes, streaming media devices, personal entertainment devices, personal computers, tablet computers, or any other hardware device. Other alternative embodiments may be implemented in software or firmware that consists of instructions executable by various computers or other hardware devices to provide the functionality described herein. Still other alternative embodiments may consist of computer program products that include tangible storage media that are readable by hardware devices and contain program instructions that are executable by the hardware devices to provide the described functionality.

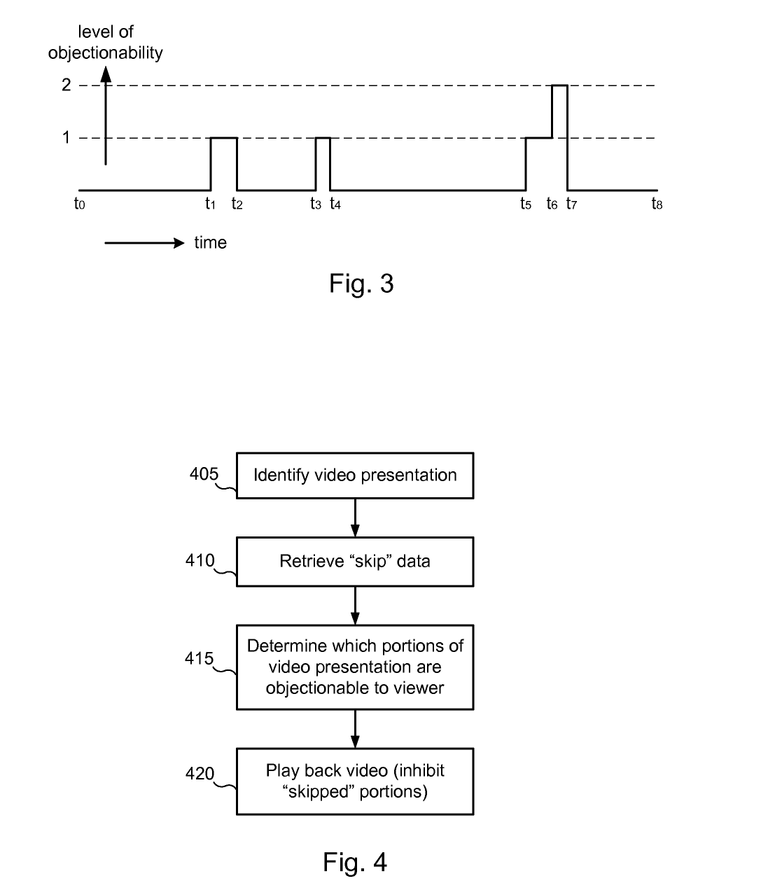

Referring to FIG. 3, a diagram illustrating the manner in which the viewing of a video presentation is customized according to a particular user's desires is shown. FIG. 3 is a timeline-style representation of a movie. The height of the graph indicates the level of objectionability of particular content within the movie. For the purposes of this example, it will be soon that the objectionability is based upon violence depicted in the movie. It can be seen that, at the beginning of the movie, the level of violence is 0, indicating that there is no significant depiction of violence. Between time t1 and time t2, however, the level of violence is 1. This may represent, for example, a physical fight between two characters in the movie. After the fight ends at time t2, the level of violence drops to 0. The level of violence again rises to one between times t3 and t4, and between times t5 and t6. Between times t6 and t7, the level of violence is 2, possibly because of the depiction of a character's violent death.

In the case of a first user who does not wish for any of the indicated violence to be displayed, the system may set the acceptable level of violence to 0. In this case, the system will display the portions of the movie for which the level of violence is 0 (times t0-t1, t2-t3, t4-t5 and t7-t8), and skip the portions for which the level of violence is greater than 0 (t1-t2, t3-t4 and t5-t7). If a second user who wishes to view the movie sets the acceptable level of violence to 1, the system will play to portions of the movie for which the level of violence is no more than 1 (t0-t6 and t7-t8), and skip the portions for which the level of violence is greater than 1 (t6-t6). If a third user views the movie w the acceptable violence level set to 2, the entire movie will be played without inhibiting any portion.

It should be noted that this example is based on one particular category (violence) of potentially objectionable content. In other embodiments, other categories can be used. Further, multiple categories can be considered in a single embodiment. For example, a viewer may not wish to view any nudity, and may therefore set the acceptable level of nudity at 0, but the viewer may find crude, but not profane language to be okay, and may therefore set the level of acceptable language at 1.

The viewer may also specify the acceptable levels of the different types of content through a more generalized indication. For instance, the viewer may specify a common movie rating, such as “PG”, which might indicate that any content which would not be found in a PG-rated movie should be skipped. This embodiment could be used, for example, to enable filmmakers to distribute their movies with variable ratings. In other words, a movie could be distributed with scenes suitable for different rating levels, and depending upon the user's input at the time the movie is viewed, particular scenes could be skipped. If the user chooses a “PG” rating, the system could play all scenes that are rated at “PG” or “G”. If the user chooses an “R” rating, the system could play all scenes that are rated at “R”, “PG-13”, “PG” or “G”.

In another alternative embodiment of the system, the skip data may identify portions of the video content that may be skipped in order to reduce the overall viewing time to fit a desired length. In this embodiment, a number of scenes may be identified as potentially disposable, while others may be identified as essential. The “disposable” scenes may be ranked in a particular order, so that if it is necessary to reduce the length of the viewing time, the scenes are marked to be skipped (starting with the lowest ranked) until the remaining scenes fit within the desired amount of time. Thus, if a user specifies that he or she wants to view only 90 minutes of a 100-minute movie, the system will skip approximately 10 minutes of the least essential scenes so that the total viewing time is no more than 90 minutes.

The functions of the present systems may be performed in a variety of ways. As noted above, there are many different sources of video content, including, but not limited to, DVD's, blu-ray disks, streaming video sources, etc. The video data can be read or received from these and other data sources in ways that are known in the art and need not be described in detail here. Similarly, the portions of the video content that are to be displayed may be processed and used to generate displayed images (and audio) in ways that are known in the art, so it is not necessary to describe them in detail here.

Referring to FIG. 4, a flow diagram illustrating one exemplary method for selectively displaying video content is shown. In this embodiment, the video presentation that a user wishes to view is first identified (405). The video presentation may be a movie, television show, or any other type of show that the user wishes to view. The system then retrieves information associated with this particular video presentation which is used to identify the portions that are to be viewed, and the portions that are to be inhibited (410). This information may be referred to herein as “skip data” because it is used to determine which portions of the video presentation to skip (or otherwise inhibit).

In one embodiment, the skip data is stored on an internet-accessible server. This server may be maintained by such entities as the Motion Picture Association of America (MPAA), video content providers (e.g., Netflix, Hulu, etc.), services that provide reviews, etc. The skip data may alternatively be defined by a user for a particular show (e.g., a viewer of the show) and may be stored locally (e.g., in a memory of the video display device). For instance, the user may own copies of various movies, and may have defined portions of the movies that will be skipped when the user's children watch the movies. In yet another alternative embodiment, the data may be stored with the video content itself. For example, a DVD or media storage device may contain video content and skip data, so that when the DVD or media storage device is read, the skip data is also read into the system.

If the skip data is stored remotely, the information may be maintained on several different servers, and may not be identical between servers. By storing the skip data on internet-accessible servers, a large number of users can benefit from the available information on the types of content contained in different video presentations. The users can also choose a server which is maintained by a service that has a similar perspective on the objectionability of content (e.g., family-oriented users can access skip data through services that are intended to promote family-oriented values). The skip data may be maintained on servers or other storage means that are independent of the video sources. Video content from a single source may be viewed according to skip data that is retrievable from multiple different sources. Similarly, skip data from a single source may be used to control the viewing of video content from multiple different sources.

The system may submit a request to one of the available servers, where the request identifies the desired video presentation. A response to the request may then be returned to the user to identify the different portions of the data that may be objectionable. The skip data may be raw data (e.g., levels of objectionability within the different categories), it may be a processed data set (e.g., a simple identification of portions of content to be skipped, based on previously specified user preferences), or it may be in some other form. In one embodiment, the returned data is raw category/level data that can be processed locally within the system. Based on user input, the raw data can be processed to determine which portions of the video presentation (if any) are objectionable (415). The user may be presented with a list or other identification of these portions of the video content, and may be given the option of approving or disapproving the portions to be skipped. Alternatively, the user may be allowed to preview the content that is potentially going to be skipped in order to allow the user to approve or disapprove each piece of content. For instance, the potentially objectionable content may be viewed apart from the non-objectionable content to allow the user to preview and approve or disapprove the potentially objectionable content more quickly.

Once it has been determined which portions of the video presentation are to be skipped, the presentation can be played back (420). As the video content is played back, the portions that have been determined to be objectionable will be skipped. For the purposes of this disclosure, “skipped” should be construed to include any manner of preventing the viewing of the objectionable content. For example, the system may skip entirely over the objectionable content, it may fast forward through this content, it may pixelate the objectionable video or garble the objectionable audio, it may pause the presentation so that the user can manually fast-forward or skip ahead, and so on.

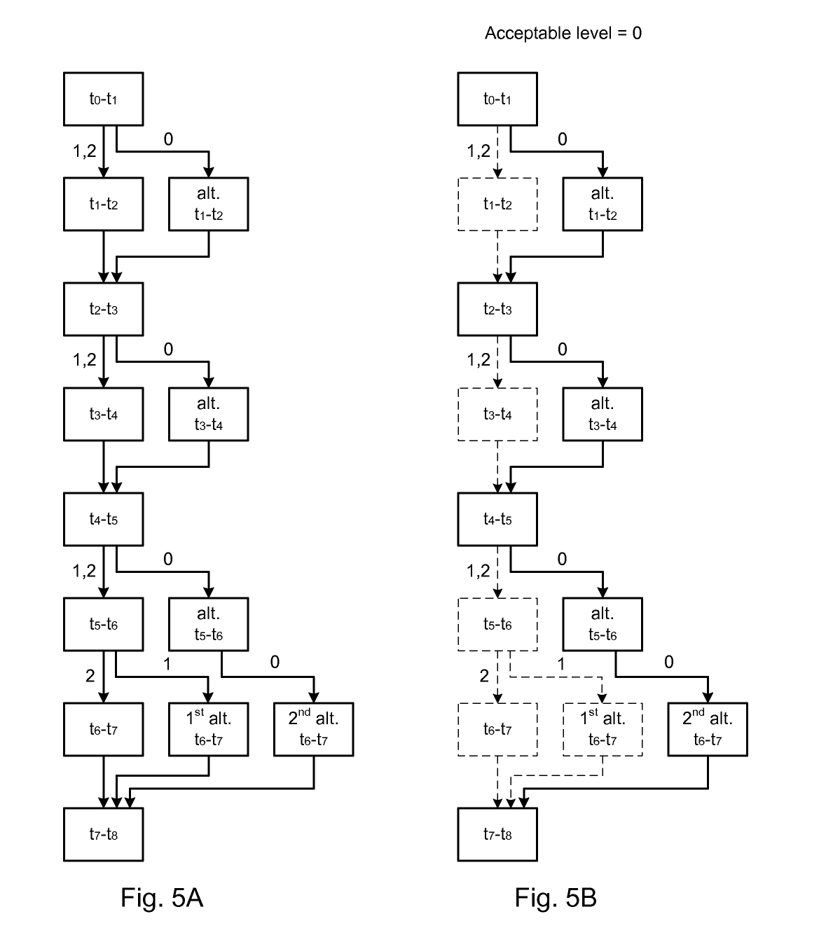

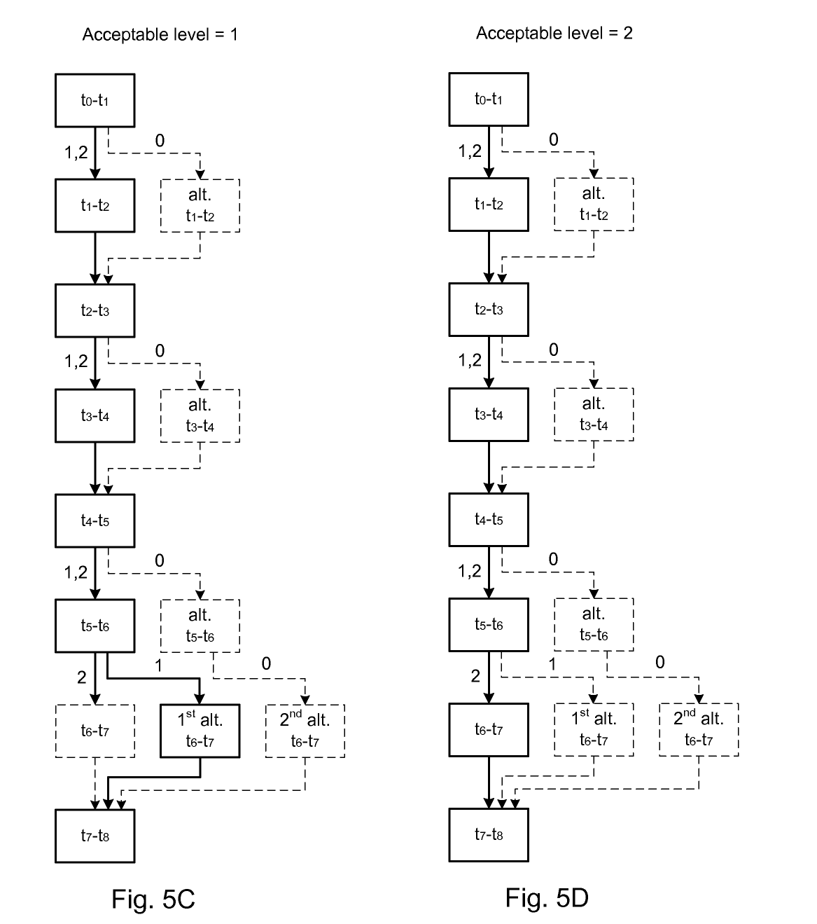

In one embodiment, objectionable portions of a video presentation may be inhibited by replacing one or more of them with substitute content. For example, referring again to the diagram of FIG. 3, a movie may include several portions (t1-t2, t3-t4 and t5-t7) that may be objectionable. For each of these potentially objectionable portions of the movie, alternative video may be provided. In other words, an alternative scene that is not considered to be objectionable may be provided, so that when a viewer indicates that the original scene is objectionable, the alternative scene may be played back instead of the objectionable scene. This may allow the creator of the movie to exercise more artistic control over the movie if he or she objects to the objectionable portions simply being skipped. The substitute video content may alternatively consist of an image indicating that an objectionable portion of the movie has been skipped. The objectionable portions of the movie may be replaced with substitute video content by the local system, or they may be substituted by a server before being provided to the local system. The replacement of objectionable portions of the movie may be performed by, for example, playing back the movie up to the point of the potentially objectionable content and then jumping to the video data corresponding to the acceptable content and playing back the acceptable content. When this is completed, the playback of the next portion of the movie (which is acceptable to all viewers) is performed. This is illustrated in the flow diagram of FIGS. 5A-5D.

In one embodiment, a user may provide information as to the objectionability of various types of content to a remote video content provider so that the provider can determine which content is to be skipped and then return to the user only the content that will actually be viewed. This may reduce the amount of video content to be transmitted to the user, thereby reducing the bandwidth required by the provider to serve the video content.

The foregoing embodiments are intended to be illustrative of the invention rather than limiting. Alternative embodiments may have many variations of the described functions and features. For instance, as noted above, objectionable content may be skipped or inhibited by omitting, fast forwarding, pixelating, pausing, etc. The skip data may be stored or provided in many different forms, such as simple lists of portions to be played or skipped, objectionability level information, “rating” information, or the like. The skip data may be maintained locally (at the viewer's location), remotely, apart from or in combination with the video content, in whole or in part. The skip data may be sufficient to be used as stored, or it may require processing (e.g., comparing the data with user selections or preferences).

It should be noted that the embodiments of the invention may include systems that are implemented in part through software, firmware or other computer or machine instructions that control the system's hardware. Various current hardware components that enable the viewing of video content (e.g., televisions, DVD/blu-ray players, media players, etc.) include video controllers or processors that execute software applications (or “apps”). These devices may, for instance, enable the device to communicate with internet-based servers to retrieve video content or other data, browse internet sites, etc. Some embodiments of the invention may include such video hardware components that are controlled by suitable apps to perform the functions described above.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments of the invention described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. For instance, the retrieval of video content, skip data and user input regarding objectionability can be performed in any order and can be performed consecutively or concurrently. The sequence of operations described herein can be interrupted, suspended, or otherwise controlled by another process, such as an operating system, kernel, etc. The routines can operate in an operating system environment or as standalone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

What is claimed is:

1. A system for customizing presentation of video content, the system comprising:
a processor coupled to one or more data sources and a video display device, wherein the data sources store video content and skip data that identifies one or more potentially objectionable portions of the video content;
wherein the processor
identifies the video content,
identifies a user-provided indication of a level of objectionability,
identifies the skip data associated with the video content,
identifies one or more objectionable portions of the video content that are identified by the skip data as potentially objectionable content and are designated as objectionable by the user-provided indication of the level of objectionability
presents non-objectionable portions of the video content to a user through the video display device, and
inhibits presentation of the identified objectionable portions of the video content.

2. The system of claim 1, further comprising one or more skip data servers that are located remotely from the processor and are coupled to the processor by a network, wherein the processor accesses the one or more skip data servers and thereby retrieves the skip data.

3. The system of claim 2, further comprising one or more video content servers that are coupled to the processor by a network, wherein the processor accesses the one or more video content servers and to retrieve the video content from the one or more video content servers

4. A method for customizing presentation of video content, the method comprising:
identifying the video content;
identifying a user-provided indication of a level of objectionability;
identifying skip data associated with the video content, wherein the skip data identifies one or more potentially objectionable portions of the video content;
identifying one or more objectionable portions of the video content that are identified by the skip data as potentially objectionable content and are designated as objectionable by the user-provided indication of the level of objectionability
presenting non-objectionable portions of the video content to a user through the video display device; and
inhibiting presentation of the identified objectionable portions of the video content.

5. The method of claim 4, wherein inhibiting presentation of the objectionable portions of the video content comprises skipping the objectionable portions of the video content.

6. The method of claim 4, wherein inhibiting presentation of the objectionable portions of the video content comprises replacing the objectionable portions of the video content with alternative content.

7. The method of claim 4, wherein inhibiting presentation of the objectionable portions of the video content comprises distorting the objectionable portions of the video content.

8. The method of claim 4, further comprising:
receiving user input that indicates a threshold level of objectionable content;
identifying portions of the video content that exceed the indicated threshold level; and
inhibiting presentation of the identified portions of the video content that exceed the indicated threshold level.

9. The method of claim 4, wherein identifying skip data associated with the video content comprises accessing, via a network, a server that stores skip data for multiple pieces of video content and retrieving skip data that is associated with the identified video content.

10. The method of claim 4, wherein identifying skip data associated with the video content comprises receiving user input that identifies one or more objectionable portions of the video content.
